(19) United States
(12) Patent Application Publication
(10) Pub. No.: US 2022/0342040 A1
(43) Pub. Date: Oct. 27, 2022

(54) LIGHT RECEPTION DEVICE, DISTANCE MEASUREMENT APPARATUS, AND METHOD OF CONTROLLING DISTANCE MEASUREMENT APPARATUS

(71) Applicant: SONY SEMICONDUCTOR SOLUTIONS CORPORATION, KANAGAWA (JP)

(72) Inventor: HIROYUKI HIRANO, TOKYO (US)

(21) Appl. No.: 17/753,622

(22) PCT Filed: Jul. 18, 2020
(86) PCT No.: PCT/JP2020/027978

§ 371 Date: Mar. 9, 2022

(30) Foreign Application Priority Data
Sep. 18, 2019 (JP) 2019-169114

(51) Int. Cl. G01S 7/484; G01S 7/481; G01S 7/4865; G01S 17/931

(52) U.S. Cl. CPC G01S 7/484; G01S 7/4816; G01S 7/4865; G01S 17/931

(57) ABSTRACT

A light reception device of the present disclosure includes: a light-receiving element that receives reflected light from a subject based on projection of light from a light source; a time calculator that calculates a rise time or a fall time of a light reception response based on entry of light into the light-receiving element; and a controller that outputs a control signal for controlling at least one of a light emission amount of the light source and a sensitivity of the light-receiving element on the basis of the rise time or the fall time calculated by the time calculator.

### TECHNICAL FIELD

The present disclosure relates to a light reception device, a distance measurement apparatus (a distance measuring apparatus), and a method of controlling a distance measurement apparatus.

### BACKGROUND ART

There is a light reception device using, as a light-receiving element, an element that generates a signal in response to reception of a photon. In a light reception device of this kind, as a measurement method for measuring a distance to a measurement target (a subject), a ToF (Time of Flight: time of flight) method is adopted which measures a time for light projected toward the measurement target to be reflected back from the measurement target.

In the ToF method, the time is measured by executing time measurement a plurality of times for a predetermined period of time and detecting a position of a peak of a histogram created by accumulating up times obtained by the plurality of times of measurement. On the basis of the time thus measured, an operation of determining a distance to the measurement target (subject) is performed. At this time, it is important that an arrival rate of the photon (=a photon flux density at the time of entry into the light-receiving element/a photon flux density at the time of emission of laser light) is constant.

Incidentally, even from the same measurement target, the position of the peak of the histogram varies depending on an intensity of reflected light from the measurement target entering the light reception device. For example, in a case where the reflected light from the measurement target is high in intensity, a phenomenon occurs in which the position of the peak of the histogram becomes relatively forward. Thus, in the case of the ToF method which defines the position of the peak of the histogram as the distance, a variation in the peak position results in a distance measurement error.

To correct the distance measurement error, a pulse width of a received-light pulse at the time of receiving the reflected light from the measurement target has been detected, and an amount of correction has been calculated on the basis of the detected pulse width of the received-light pulse and a time difference between emission of light from a light source and returning of the light to thereby calculate the distance on the basis of the time difference and the amount of correction (see PTL 1, for example).

### CITATION LIST

### Patent Literature

PTL 1: Japanese Unexamined Patent Application Publication No. 2016-142534

### SUMMARY OF THE INVENTION

### Problem to be Solved by the Invention

As described above, according to the existing technique described in PTL 1, a pulse width of a received-light pulse is detected and an amount of correction is calculated on the basis of the detected pulse width of the received-light pulse. However, with the ToF method in which an arrival rate of a photon is expected to be constant, the existing technique which performs control based on the pulse width of the received-light pulse can result in lower reliability of distance measurement in a case where the pulse width of the received-light pulse has no correlation with the arrival rate.

It is an object of the present disclosure to provide a light reception device that makes it possible to perform a highly reliable distance measurement, a distance measurement apparatus that uses the light reception device, and a method of controlling the distance measurement apparatus.

### Means for Solving the Problem

A light reception device of the present disclosure to achieve the above-described object includes:

a light-receiving element that receives reflected light from a subject based on projection of light from a light source;

a time calculator that calculates a rise time or a fall time of a light reception response based on entry of light into the light-receiving element; and

a controller that outputs a control signal for controlling at least one of a light emission amount of the light source and a sensitivity of the light-receiving element on the basis of the rise time or the fall time calculated by the time calculator.

A distance measurement apparatus of the present disclosure to achieve the above-described object includes

a light source that projects light onto a measurement target, and

a light reception device that detects light reflected off the measurement target. Then, the light reception device includes:

a light-receiving element that receives reflected light from a subject based on projection of light from the light source;

a time calculator that calculates a rise time or a fall time of a light reception response based on entry of light into the light-receiving element; and

a controller that outputs a control signal for controlling at least one of a light emission amount of the light source and a sensitivity of the light-receiving element on the basis of the rise time or the fall time calculated by the time calculator.

A method of controlling a distance measurement apparatus of the present disclosure to achieve the above-described object includes, in a distance measurement apparatus including a light source that projects light onto a measurement target, and a light reception device that receives light reflected off the measurement target,

calculating a rise time or a fall time of a light reception response of a light-receiving element that receives reflected light from a subject based on projection of light from the light source; and

outputting a control signal for controlling at least one of a light emission amount of the light source and a sensitivity of the light-receiving element on the basis of the rise time or the fall time calculated.

### BRIEF DESCRIPTION OF THE DRAWINGS

FIG. 1 is a schematic configuration diagram illustrating an example of a distance measurement apparatus to which the technology according to the present disclosure is applied.

FIG. 2A and FIG. 2B are block diagrams each illustrating an example of a specific configuration of the distance measurement apparatus according to the present application example.

FIG. 3 is a circuit diagram illustrating an example of a basic pixel circuit using an SPAD element.

FIG. 4A is a characteristic diagram illustrating a current-voltage characteristic of a PN junction of the SPAD element, and FIG. 4B is a waveform diagram for description of a circuit operation of the pixel circuit.

FIG. 5A is a block diagram illustrating an example of a configuration of a light reception device according to an embodiment of the present disclosure, and FIG. 5B is a waveform diagram illustrating a response waveform of each part of the light reception device of FIG. 5A.

FIG. 6 is a schematic perspective diagram illustrating an example of a stacked structure of the light reception device according to the embodiment of the present disclosure.

FIG. 7 is a block diagram illustrating an example of a configuration of a distance measurement apparatus according to an embodiment of the present disclosure.

FIG. 8 is a flowchart illustrating an example of a flow of a distance measurement process by the distance measurement apparatus according to the embodiment of the present disclosure.

FIG. 9 is a block diagram illustrating a configuration example of a light reception device including a computing unit according to Example 1.

FIG. 10A is a diagram illustrating a ToF histogram, FIG. 10B is a diagram illustrating a fall time t_{f} histogram in a case where signal light is excessively high in intensity, and FIG. 10C is a diagram illustrating a histogram in a case where the intensity of the signal light is appropriate.

FIG. 11 is a diagram illustrating a configuration example of a device arrangement according to Example 2.

FIG. 12 is a block diagram illustrating a configuration example of a light reception device including a computing unit according to Example 3.

FIG. 13 is a block diagram illustrating a configuration example of a light reception device according to Example 4.

FIG. 14 is a block diagram illustrating a configuration example of a light reception device in a case of including three time calculators each including a TDC.

FIG. 15 is a block diagram illustrating a schematic configuration example of a vehicle control system that is an example of a mobile body control system to which the technology according to the present disclosure is applicable.

FIG. 16 is a diagram illustrating an example of an installation position of the distance measurement apparatus.

### MODES FOR CARRYING OUT THE INVENTION

In the following, modes for carrying out the technology of the present disclosure (hereinafter referred to as “embodiments”) are described in detail with reference to the drawings. The technology of the present disclosure is not limited to the embodiments. In the following description, the same components, or components having the same function are denoted by the same reference signs, and redundant description is omitted. It is to be noted that description is given in the following order.

### 1. General Description of Light Reception Device, Distance Measurement Apparatus, and Method of Controlling the Same of Present Disclosure

### 2. Distance Measurement Apparatus to Which Technology According to Present Disclosure Is Applied

2-1. Specific Configuration Example of Distance Measurement Apparatus

2-2. Basic Pixel Circuit Example Using SPAD Element

2-3. Circuit Operation Example of Pixel Circuit Using SPAD Element

### 3. Embodiment of Present Disclosure

3-1. Light Reception Device According to Embodiment

3-2. Distance Measurement Apparatus According to Embodiment

3-3. Example 1 (Specific Circuit Configuration Example of Computing Unit)

3-4. Example 2 (Example of Device Arrangement of Laser Light Source and SPAD Element)

3-5. Example 3 (Example of Correcting Distance Measurement Result Using Correction Table)

3-6. Example 4 (Example of Thinning out Provision of Second Time Calculator Relative to SPAD Element)

### 4. Modification Examples

### 5. Application Example of Technology According to Present Disclosure (Example of Mobile Body)

### 6. Possible Configurations of Present Disclosure

### <General Description of Light Reception Device, Distance Measurement Apparatus, and Method of Controlling the Same of Present Disclosure>

In a light reception device, a distance measurement apparatus, and a method of controlling the same of the present disclosure, a controller may be configured to control at least one of a light emission amount of a light source and a sensitivity of a light-receiving element to cause a rise time or a fall time calculated by a time calculator to become a predetermined reference time. Further, the predetermined reference time may be a rise time or a fall time of a light reception response when a distance measurement is performed under background light.

In the light reception device, the distance measurement apparatus, and the method of controlling the same of the present disclosure including the preferred configurations described above, the controller may be configured to control the light emission amount of the light source by changing a current value of a drive current of the light source. Further, the controller may be configured to control the sensitivity of the light-receiving element by changing a voltage value of a voltage to be applied to the light-receiving element.

In the light reception device, the distance measurement apparatus, and the method of controlling the same of the present disclosure including the preferred configurations described above, the time calculator may have a configuration including a plurality of time calculators having thresholds different from each other. Further, the plurality of time calculators may have configurations including combinations of inverters and time measurement sections.

Further, in the light reception device, the distance measurement apparatus, and the method of controlling the same of the present disclosure including the preferred configurations described above, the thresholds of the plurality of time calculators different from each other may be configured to be supplied by threshold voltages of the inverters. Further, the inverters may include CMOS inverters, and the thresholds of the plurality of time calculators different from each other may be configured to be set by causing transistors included in the CMOS inverters to be different from each other in threshold voltage, or by causing the transistors to be different from each other in size ratio.

Further, in the light reception device, the distance measurement apparatus, and the method of controlling the same of the present disclosure including the preferred configurations described above, the time calculator may be configured to include a computing unit that calculates the rise time or the fall time of the light reception response on the basis of difference value information obtained from calculation results of the plurality of time calculators. Further, the computing unit may have a configuration including a subtractor that obtains the difference value information on the basis of the calculation results of the plurality of time calculators, a histogram generator that generates a histogram of the rise time or the fall time of the light reception response on the basis of the difference value information obtained by the subtractor, and an average computing section that determines an average value of the histogram generated by the histogram generator as the rise time or the fall time of the light reception response.

Further, in the light reception device, the distance measurement apparatus, and the method of controlling the same of the present disclosure including the preferred configurations described above, the controller may be configured to perform feedback control on at least one of the light emission amount of the light source and the sensitivity of the light-receiving element on the basis of the rise time or the fall time calculated by the time calculator. Further, the computing unit may be configured to acquire a photon flux density from a calculation result of the rise time or the fall time of the light reception response.

Further, in the light reception device, the distance measurement apparatus, and the method of controlling the same of the present disclosure including the preferred configurations described above, the computing unit may have a configuration including a subtractor that obtains difference value information on the basis of the calculation results of the plurality of time calculators, a histogram generator that generates a histogram of the rise time or the fall time of the light reception response on the basis of the difference value obtained by the subtractor, a correction table that associates photon flux density information based on the difference value information obtained by the subtractor and distance information to be corrected with each other, and a correction section that corrects the distance information using the correction table on the basis of the rise time or the fall time of the light reception response.

Further, in the light reception device, the distance measurement apparatus, and the method of controlling the same of the present disclosure including the preferred configurations described above, the time calculator may have a configuration including a first time calculator that calculates the rise time or the fall time of the light reception response with a first threshold as a reference, and a second time calculator that calculates the rise time or the fall time of the light reception response with a second threshold different from the first threshold as a reference. Then, the second time calculator may be configured to be provided in a thinned-out manner relative to the light-receiving element in a pixel array section.

Further, in the light reception device, the distance measurement apparatus, and the method of controlling the same of the present disclosure including the preferred configurations described above, the light-receiving element may be configured to include an element that generates a signal in response to reception of a photon. Further, the light-receiving element may be configured to include a single-photon avalanche diode.

Further, in the distance measurement apparatus of the present disclosure including the preferred configurations described above, the light source and the light-receiving element may be configured in a one-dimensional, two-dimensional, or three-dimensional array, and when the light source and the light-receiving element are in a 1-to-N (N≥1) correspondence relationship, feedback control may be performed on the light emission amount of each light source independently in accordance with illuminance information of the light-receiving element.

<Distance Measurement Apparatus to which Technology According to Present Disclosure is Applied>

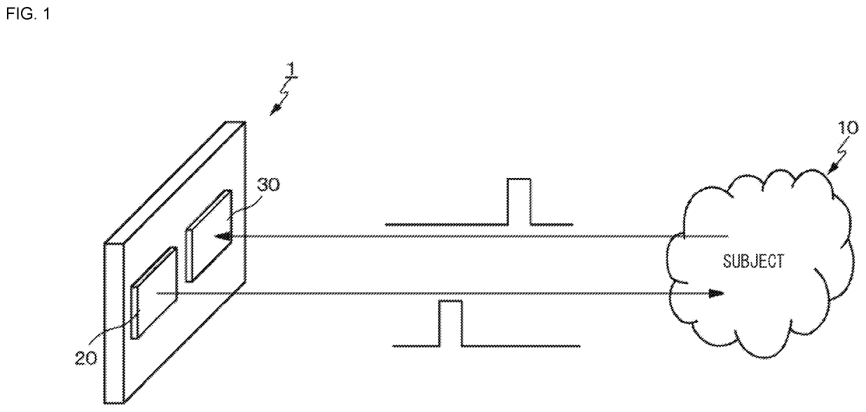

FIG. 1 is a schematic configuration diagram illustrating an example of a distance measurement apparatus to which the technology according to the present disclosure is applied. A distance measurement apparatus 1 according to the present application example adopts, as a measurement method for measuring a distance to a subject 10 that is a measurement target, a ToF method that measures a time of flight for light (e.g., laser light having a peak wavelength in an infrared wavelength region) projected toward the subject 10 to be reflected back from the subject 10. In order to implement distance measurement by the ToF method, the distance measurement apparatus 1 according to the present application example includes a light source 20 and a light reception device 30. Furthermore, a light reception device according to an embodiment of the present disclosure to be described later is usable as the light reception device 30.

### [Specific Configuration Example of Distance Measurement Apparatus]

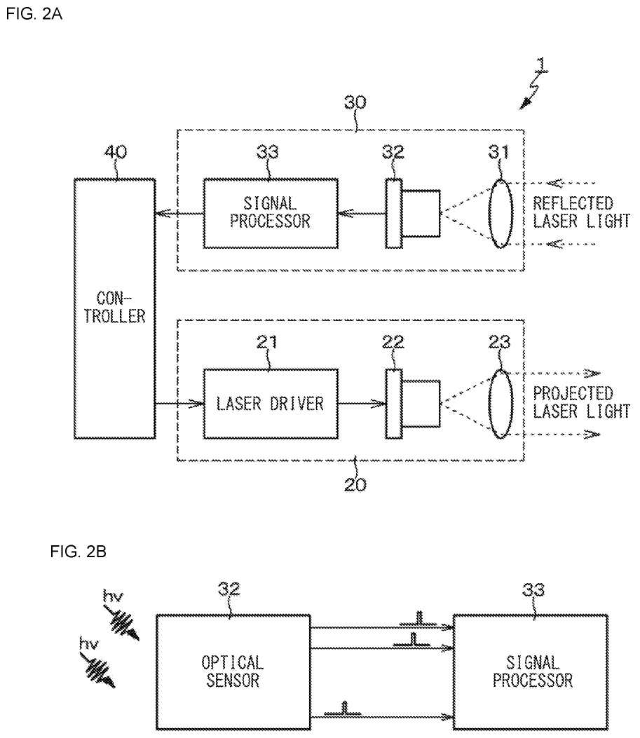

FIG. 2A and FIG. 2B each illustrate an example of a specific configuration of the distance measurement apparatus 1 according to the present application example. The light source 20 includes, for example, a laser driver 21, a laser light source 22, and a diffusion lens 23, and projects laser light onto the subject 10. The laser driver 21 drives the laser light source 22 under control by a controller 40. The laser light source 22 includes, for example, a semiconductor laser, and is driven by the laser driver 21 to emit laser light. The diffusion lens 23 diffuses the laser light emitted from the laser light source 22, and projects the laser light onto the subject 10.

The light reception device 30 includes a light-receiving lens 31, an optical sensor 32 which is a light-receiving unit, and a signal processor 33, and receives reflected laser light which is laser light projected by a laser projection unit 20 and reflected back from the subject 10. The light-receiving lens 31 condenses the reflected laser light from the subject 10 onto a light-receiving surface of the optical sensor 32. The optical sensor 32 receives, for each pixel, the reflected laser light from the subject 10 having passed through the light-receiving lens 31, and performs photoelectric conversion of the reflected laser light. As the optical sensor 32, it is possible to use a two-dimensional array sensor (a so-called area sensor) including pixels that each include a light-receiving element and are two-dimensionally arranged in a matrix form (an array form).

An output signal of the optical sensor 32 is supplied to the controller 40 via the signal processor 33. The controller 40 includes, for example, a CPU (Central Processing Unit: central processing unit) or the like. The controller 40 controls the light source 20 and the light reception device 30, and measures a time for laser light projected from the light source 20 toward the subject 10 to be reflected back from the subject 10. It is possible to determine the distance to the subject 10 on the basis of the time measured.

As a time measurement method, a timer is started at a timing at which the light source 20 projects pulsed light, and the timer is stopped at a timing at which the light reception device 30 receives the pulsed light, thereby measuring the time. As another time measurement method, pulsed light may be projected from the light source 20 with a predetermined period, and the period at the time when the light reception device 30 receives the pulsed light may be detected to measure the time on the basis of a phase difference between the period of the light emission and the period of the light reception. The time measurement is performed a plurality of times to measure the time by detecting the position of a peak of a ToF histogram created by accumulating up times obtained by the plurality of times of measurement.

Then, in the distance measurement apparatus 1 according to the present application example, a sensor in which the light-receiving element of the pixel includes an element that generates a signal in response to reception of a photon, such as an SPAD (Single Photon Avalanche Diode: single-photon avalanche diode) element, is used as the optical sensor 32. In other words, the light reception device 30 in the distance measurement apparatus 1 according to the present application example has a configuration in which the light-receiving element of the pixel includes an SPAD element. It is to be noted that the light-receiving element is not limited to the SPAD element, and may include any of various elements, including an APD (Avalanche Photo Diode) and a CAPD (Current Assisted Photonic Demodulator).

### [Basic Pixel Circuit Example Using SPAD Element]

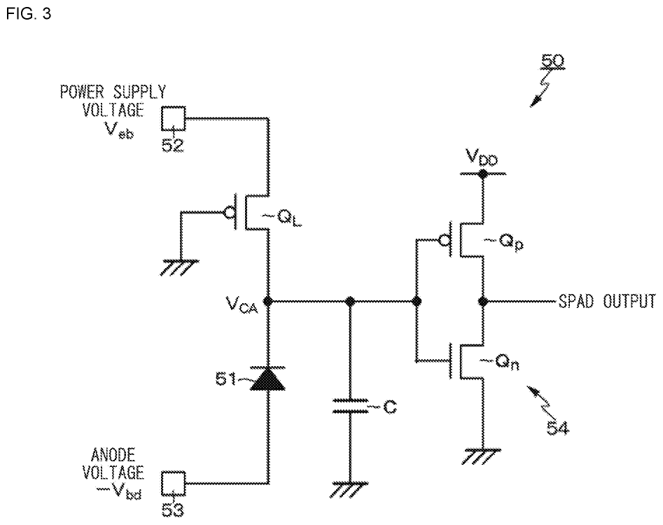

FIG. 3 illustrates an example of a basic pixel circuit in the light reception device 30 using the SPAD element. Here, a basic configuration of one pixel is illustrated.

A basic pixel circuit of a pixel 50 using an SPAD element has a configuration in which a SPAD element 51 has a cathode electrode coupled to a terminal 52 to be supplied with a voltage V_{eb} via a P-type MOS transistor Q_{L} which is a load, and an anode electrode coupled to a terminal 53 to be supplied with an anode voltage V_{bd}. As the anode voltage V_{bd}, a large negative voltage that causes avalanche multiplication to occur is applied. A capacitive element C is coupled between the anode electrode and a ground. Then, a cathode voltage V_{CA} of the SPAD element 51 is derived as an SPAD output (a pixel output) via an inverter (a CMOS inverter) 54 including a P-type MOS transistor Qₚ and an N-type MOS transistor Qₙ that are coupled in series to each other.

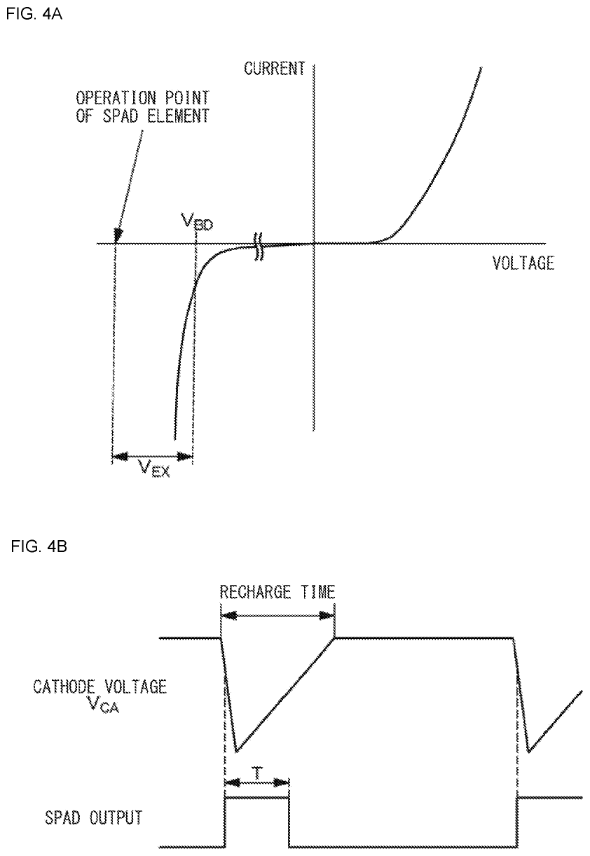

A voltage equal to or higher than a breakdown voltage V_{BD} is applied to the SPAD element 51. An excess voltage equal to or higher than the breakdown voltage V_{BD} is called an excess bias voltage V_{EX}, and is typically a voltage of about 2 V to 5 V. The SPAD element 51 operates in a region called Geiger mode in which there is no DC steady point. FIG. 4A illustrates an I (current)-V (voltage) characteristic of a PN junction of the SPAD element 51.

### [Circuit Operation Example of Pixel Circuit Using SPAD Element]

Next, an example of a circuit operation of the pixel circuit having the above-described configuration will be described with reference to a waveform diagram in FIG. 4B.

With no current flowing through the SPAD element 51, a voltage having a value of V_{eb}−V_{bd} is applied to the SPAD element 51. This voltage value (V_{eb}−V_{bd}) is (V_{BD}+V_{EX}). Then, electrons generated at the PN junction of the SPAD element 51 due to a dark electron generation rate DCR (Dark Count Rate) or light irradiation cause an avalanche multiplication to occur, thereby generating an avalanche current. This phenomenon stochastically occurs even in a light-blocked state (that is, a state where no light enters). This is the dark electron generation rate DCR.

In a case where the cathode voltage V_{CA} drops and a voltage between terminals of the SPAD element 51 becomes the breakdown voltage V_{BD} of a PN diode, the avalanche current stops. Then, electrons generated and accumulated by the avalanche multiplication are discharged by a resistive element R (or the P-type MOS transistor Q_{L}) which is a load, and the cathode voltage V_{CA} recovers to the voltage V_{eb}, and returns to an initial state.

In a case where light enters the SPAD element 51 and generates even a single electron-hole pair, the pair becomes a source of generation of an avalanche current. Thus, it is possible to detect the entry of even a single photon at a certain detection efficiency PDE (Photon Detection Efficiency). The detection efficiency PDE at which this photon is detectable is generally about several % to about 20%.

The above-described operations are repeated. In addition, in this series of operations, a waveform of the cathode voltage V_{CA} is shaped by the inverter 54, and a pulse signal having a pulse width T with an arrival time of one photon as a start point becomes the SPAD output (pixel output).

### Embodiment of Present Disclosure

Next, description is given of a distance measurement apparatus according to an embodiment of the present disclosure that is usable as the distance measurement apparatus 1 having the above-described configuration, and a light reception device according to an embodiment of the present disclosure that is usable in the distance measurement apparatus.

If a large amount of photons enter the SPAD element 51 all at once, a response of the SPAD element 51 becomes faster. More specifically, there is a relationship that the reflectance of the measurement target ∝ the arrival rate of the photon ∝ the illuminance of a surrounding environment, and therefore an error occurs in the ToF histogram depending on the illuminance of the surrounding environment. As a result, the accuracy of distance measurement can deteriorate depending on the illuminance of the surrounding environment.

The embodiments of the present disclosure each have an objective of making it possible to perform a highly reliable distance measurement irrespective of the illuminance (without being affected by the illuminance) of the surrounding environment. Then, for the objective, the light reception device according to the embodiment of the present disclosure calculates a rise time tᵣ or a fall time t_{f} of a light reception response based on entry of light into the light-receiving element, and controls at least one of the light emission amount of the light source and the sensitivity (detection efficiency PDE: Photon Detection Efficiency) of the light-receiving element on the basis of the rise time tᵣ or the fall time t_{f}. Further, for the above-described objective, the distance measurement apparatus according to the embodiment of the present disclosure may have a configuration using the light reception device having the above-described configuration.

The light reception device and the distance measurement apparatus according to the present embodiments each include, as a time calculator that calculates the rise time tᵣ or the fall time t_{f} of the light reception response, a plurality of time measurement sections having thresholds different from each other. A controller that controls at least one of the light emission amount of the light source and the sensitivity of the light-receiving element performs control to cause the rise time or the fall time calculated by the time calculator including the plurality of time measurement sections to become a predetermined reference time (reference value) (specifically, to converge to a predetermined reference value±α).

The following will describe a specific configuration of each of the light reception device according to the embodiment of the present disclosure and the distance measurement apparatus according to the embodiment of the present disclosure. In the following, description will be given with reference to a case of calculating the fall time t_{f} of the light reception response based on entry of light into the light-receiving element by way of example; however, a case of calculating the rise time tᵣ is basically the same as the case of calculating the fall time t_{f}.

### [Light Reception Device According to Embodiment]

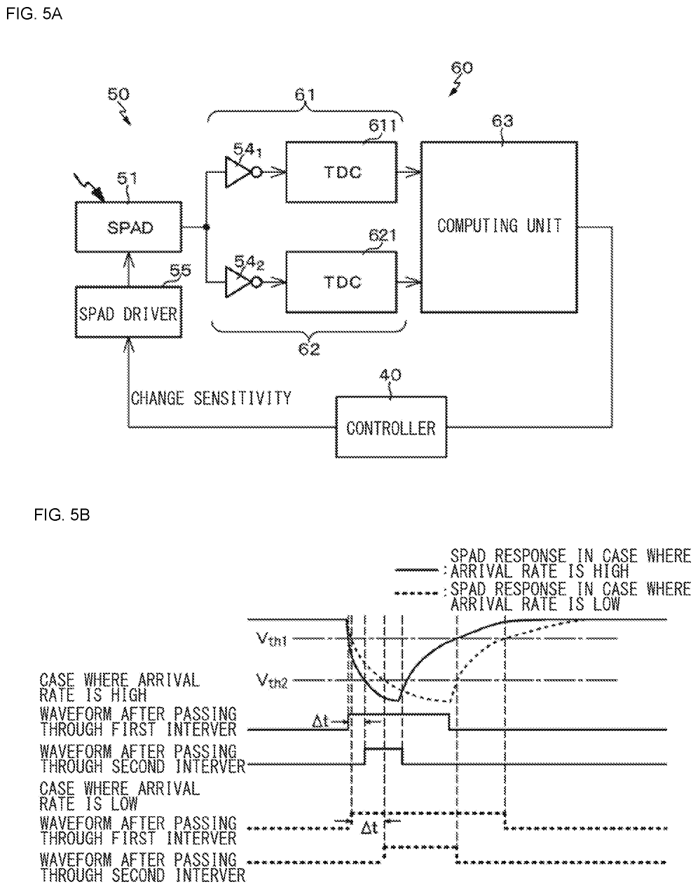

FIG. 5A is a block diagram illustrating an example of a configuration of the light reception device according to the embodiment of the present disclosure. The light reception device according to the embodiment has a configuration including a time calculator 60 that calculates the fall time t_{f} of the light reception response. The time calculator 60 includes, as the plurality of time measurement sections having thresholds different from each other, for example, two (two systems of) time measurement sections, that is, a first time calculator 61 and a second time calculator 62, and further includes a computing unit 63.

The first time calculator 61 includes a first inverter 54₁ corresponding to the inverter 54 in FIG. 3, and a TDC (Time-to-Digital Converter: a time measurement section) 611. The first time calculator 61 has a first threshold Vₜₕ₁, and detects a fall of the light reception response based on entry of light into the SPAD element 51. The first threshold Vₜₕ₁ is a threshold voltage of the first inverter 54₁. The second time calculator 62 includes a second inverter 54₂ corresponding to the inverter 54 in FIG. 3, and a TDC 62₁. The second time calculator 62 has a second threshold Vₜₕ₂ smaller than the first threshold Vₜₕ₁ (Vₜₕ₁>Vₜₕ₂), and detects the fall of the light reception response based on entry of light into the SPAD element 51. The second threshold Vₜₕ₂ is a threshold voltage of the second inverter 54₂.

It is possible for the first threshold Vₜₕ₁ and the second threshold Vₜₕ₂ different from each other to be set by causing the P-type MOS transistor Qₚ and the N-type MOS transistor Qₙ included in the CMOS inverter 54 illustrated in FIG. 3 to be different from each other in threshold voltage Vₜₕ, size ratio, that is, W (channel width)/L (channel length), or power supply voltage.

FIG. 5B is a waveform diagram illustrating a response waveform of each part of the light reception device of FIG. 5A. In FIG. 5B, the response waveform of the SPAD element 51 in a case where the arrival rate of the photon (a photon flux density at the time of entry into the SPAD/a photon flux density at the time of emission of laser light) is relatively high is illustrated in a solid line, and the response waveform of the SPAD element 51 in a case where the arrival rate is relatively low is illustrated in a dotted line. Further, the response waveforms of the SPAD element 51 after passing through the first inverter 54₁ and the second inverter 54₂ in the case where the arrival rate is relatively high are illustrated in solid lines, and the response waveforms of the SPAD element 51 after passing through the first inverter 54₁ and the second inverter 54₂ in the case where the arrival rate is relatively low are illustrated in dotted lines.

As illustrated in the waveform diagram in FIG. 5B, the first inverter 54₁ has an output whose polarity is reversed when the response waveform of the SPAD element 51 in the case where the arrival rate is relatively high/low falls below the first threshold Vₜₕ₁. The second inverter 54₂ has an output whose polarity is reversed when the response waveform of the SPAD element 51 in the case where the arrival rate is relatively high/low falls below the second threshold Vth₂. In the light reception device, a time Δt from a point in time at which the response waveform of the SPAD element 51 falls below the first threshold Vₜₕ₁ to a point in time at which the response waveform of the SPAD element 51 falls below the second threshold Vₜₕ₂ is determined from a histogram result.

The first time calculator 61 detects a polarity reversal of the output of the first inverter 54₁, and measures a time when the response waveform of the SPAD element 51 falls below the first threshold Vₜₕ₁ using the TDC 611. The second time calculator 62 detects a polarity reversal of the output of the second inverter 54₂, and measures a time when the response waveform of the SPAD element 51 falls below the second threshold Vₜₕ₂ using the TDC 621. On the basis of the respective measurement results of the first time calculator 61 and the second time calculator 62, the computing unit 63 calculates the fall time t_{f} of the light reception response based on entry of light into the SPAD element 51.

A calculation result of the computing unit 63, that is, information of the fall time t_{f} of the light reception response is supplied to the controller 40. The controller 40 corresponds to the controller 40 in FIG. 2A, and outputs a control signal for controlling the sensitivity (detection efficiency PDE) of the SPAD element 51 on the basis of the fall time t_{f} of the light reception response calculated by the computing unit 63. A SPAD driver 55 receives the control signal outputted from the controller 40 and controls the sensitivity of the SPAD element 51.

Specifically, under control by the controller 40, the SPAD driver 55 performs control to reduce the sensitivity of the SPAD element 51 until the fall time t_{f} of the light reception response converges to the predetermined reference value (reference time)±α. Here, regarding the “predetermined reference value”, in view of no dependence of background light on distance, it is possible to set a fall time t_{f} for the background light as the reference value (reference time) by bringing a system into operation without signal light in advance, and acquiring the fall time t_{f} of the light reception response when performing a distance measurement under the background light. When indoors, it is possible to define a fall time t_{f} of a point that appears to be at a long distance as the reference value. Further, it is also possible to define a fall time t_{f} of a reference pixel as the reference value.

The sensitivity (detection efficiency PDE) of the SPAD element 51 is controllable by changing a voltage value (V_{eb}−V_{bd}) of a voltage to be applied to the SPAD element 51. For example, the controller 40 is able to reduce the sensitivity of the SPAD element 51 by performing control to reduce the voltage value (V_{eb}−V_{bd}) of the voltage to be applied to the SPAD element 51.

In the light reception device according to the present embodiment, means for acquiring the fall time t_{f} (or the rise time tᵣ) of the light reception response, that is, the first time calculator 61 and the second time calculator 62 are configured to include respective combinations of the first inverter 54₁ and the second inverter 54₂ having threshold voltages different from each other with the TDC 611 and the TDC 621. It is to be noted that while such combinations are advantageous from the viewpoint of reducing cost, the means for acquiring the fall time t_{f} (or the rise time tᵣ) of the light reception response is not limited to the configuration including the above-described combinations. As another configuration, for example, a configuration including a combination of a digital-to-analog converter or a reference voltage source for setting different thresholds, a comparator, and a TDC is also possible.

As described above, in the light reception device according to the present embodiment, the fall time t_{f} of the light reception response of the SPAD element 51 is acquired and feedback control is performed on the sensitivity of the SPAD element 51 to cause the acquired fall time t_{f} to become the reference value (to converge to the reference value±α). This feedback control makes it possible to cause the arrival rate to be constant all the time, and therefore allows for higher stabilization of the photon flux density than in a case of control based on the pulse width of the light reception response. It is thus possible to perform a distance measurement that is higher in reliability.

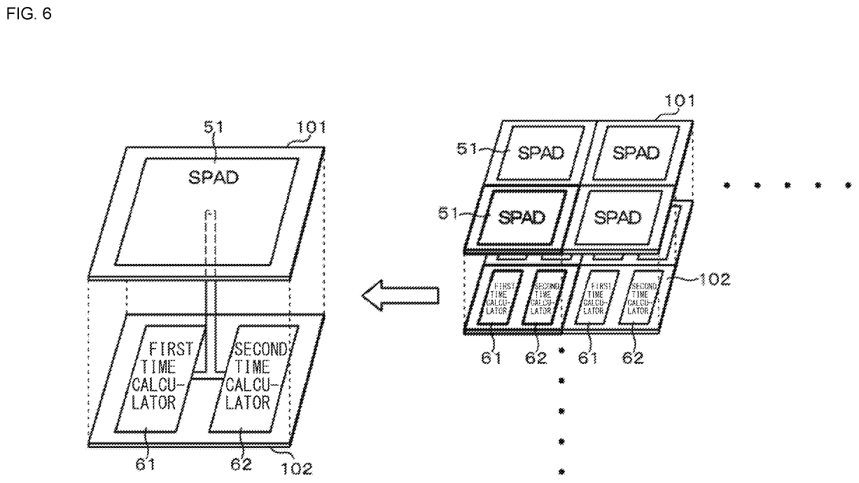

As a chip structure of the light receiving device according to the present embodiment having the above-described configuration, it is possible to employ a stacked structure including a stack of a plurality of semiconductor substrates. Specifically, as illustrated in FIG. 6, with a first semiconductor substrate as an upper chip 101, the pixel 50 including the SPAD element 51 is provided on the upper chip 101, and with a second semiconductor substrate as a lower chip 102, the first time calculator 61 and the second time calculator 62 are provided on the lower chip 102. Then, the upper chip 101 provided with the pixel 50 including the SPAD element 51 and the lower chip 102 provided with the first time calculator 61 and the second time calculator 62 are stacked.

### [Distance Measurement Apparatus According to Embodiment]

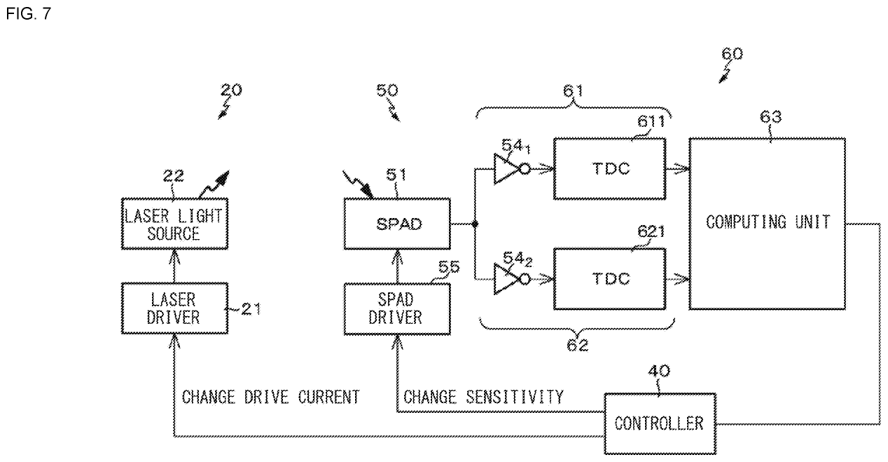

FIG. 7 is a block diagram illustrating an example of a configuration of the distance measurement apparatus according to the embodiment of the present disclosure. The distance measurement apparatus according to the present embodiment has a configuration including the light source 20, that is, the laser driver 21 and the laser light source 22, in addition to the pixel 50 and the time calculator 60 of the light reception device illustrated in FIG. 5A.

In the distance measurement apparatus according to the present embodiment, on the basis of the fall time t_{f} of the light reception response calculated by the computing unit 63, the controller 40 outputs a control signal for controlling the light emission amount of the laser light source 22 or the sensitivity (detection efficiency PDE) of the SPAD element 51, or both of the light emission amount of the laser light source 22 and the sensitivity of the SPAD element 51, in other words, at least one of the light emission amount of the laser light source 22 and the sensitivity of the SPAD element 51.

The SPAD driver 55 receives the control signal outputted by the controller 40 and controls the sensitivity (detection efficiency PDE) of the SPAD element 51. Specifically, under the control by the controller 40, the SPAD driver 55 performs control to reduce the sensitivity of the SPAD element 51 by, for example, changing the voltage value (V_{eb}−V_{bd}) of the voltage to be applied to the SPAD element 51 to cause the fall time t_{f} of the light reception response to converge to the predetermined reference value (reference time)±α.

The laser driver 21 receives the control signal outputted by the controller 40 and controls the light emission amount of the laser light source 22. Specifically, under the control by the controller 40, the laser driver 21 performs control to reduce the light emission amount (intensity) of the laser light source 22 by, for example, changing a current value of a drive current of the laser light source 22 to cause the fall time t_{f} of the light reception response to converge to the predetermined reference value (reference time)±α.

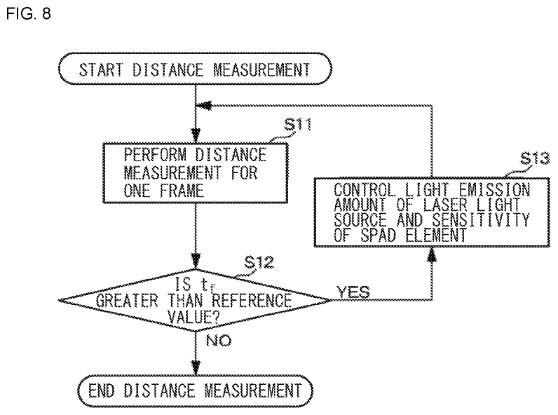

An example of a distance measurement process by the distance measurement apparatus according to the present embodiment is illustrated in a flowchart in FIG. 8. This distance measurement process is executed under the control by the controller 40.

The controller 40 first performs a distance measurement for certain one frame (step S11). Next, on the basis of respective measurement results of the first time calculator 61 and the second time calculator 62, the controller 40 determines whether or not the fall time t_{f} of the light reception response calculated by the computing unit 63 is greater than the reference value (reference time) set in advance (step S12). If the fall time t_{f} is not greater than the reference value (NO in S12), the controller 40 causes this distance measurement process to end.

If the controller 40 determines that the fall time t_{f} of the light reception response is greater than the reference value (YES in S12), the controller 40 controls the light emission amount of the laser light source 22 and the sensitivity of the SPAD element 51 (step S13) to cause the fall time t_{f} of the light reception response to converge to the predetermined reference value (reference time)±α, and thereafter causes the process to return to step S11. The control of the light emission amount of the laser light source 22 is achievable by, for example, changing the drive current of the laser light source 22. The control of the sensitivity of the SPAD element 51 is achievable by changing the voltage value (V_{eb}−V_{bd}) of the voltage to be applied to the SPAD element 51.

It is to be noted that while the description here has been given of the case of controlling both of the light emission amount of the laser light source 22 and the sensitivity of the SPAD element 51 by way of example, only the light emission amount of the laser light source 22 or only the sensitivity of the SPAD element 51 may be controlled under the control by the controller 40.

As described above, in the distance measurement apparatus according to the present embodiment, the fall time t_{f} (or the rise time tᵣ) of the light reception response of the SPAD element 51 is acquired and feedback control is performed on the sensitivity of the SPAD element 51 to cause the acquired fall time t_{f} (or rise time tᵣ) to become the reference value (to converge to the reference value±α). This feedback control makes it possible to cause the arrival rate to be constant all the time, and therefore allows for higher stabilization of the photon flux density than in the case of control based on the pulse width of the light reception response. It is thus possible to perform a distance measurement that is higher in reliability.

Further, according to the distance measurement apparatus of the present embodiment, by virtue of the feedback control, there is also an advantage that it is not necessary to correct the acquired fall time t_{f} (or rise time tᵣ) or to create a table for correction.

The following will describe specific examples of the light reception device according to the present embodiment or the distance measurement apparatus according to the present embodiment for making it possible to perform a highly reliable distance measurement irrespective of illuminance of the surrounding environment.

### Example 1

Example 1 is a specific circuit configuration example of the computing unit 63 that calculates the fall time t_{f} (or the rise time tᵣ) of the light reception response of the SPAD element 51. For Example 1, although description is given with reference to a case of calculating the fall time t_{f} by way of example, a case of calculating the rise time tᵣ is the same as the case of calculating the fall time t_{f}. The same applies to each example described later in this regard.

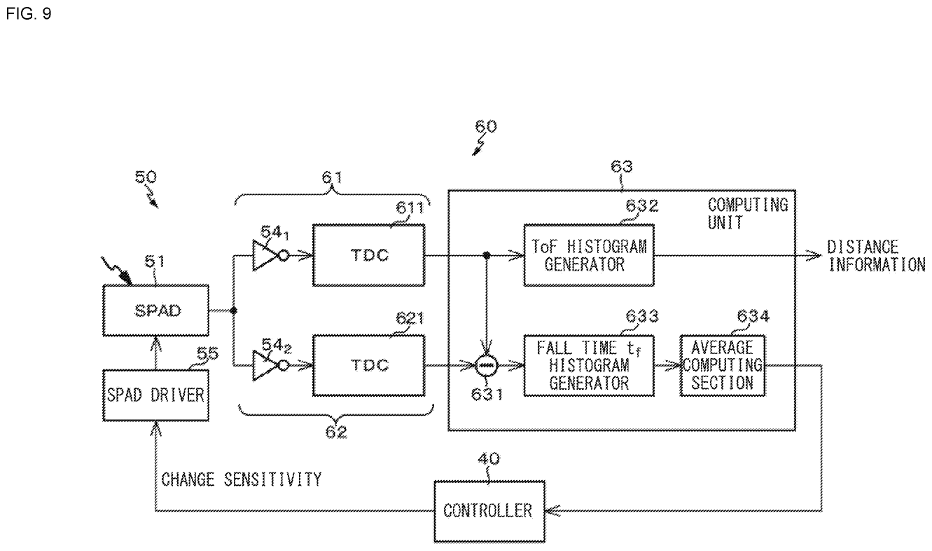

FIG. 9 illustrates an example of a configuration of a light reception device including the computing unit 63 according to Example 1. As illustrated in FIG. 9, the computing unit 63 that calculates the fall time t_{f} of the light reception response has a configuration including a subtractor 631, a ToF histogram generator 632, a fall time t_{f} histogram generator 633, and an average computing section 634.

In the computing unit 63 having the above-described configuration, the subtractor 631 determines a difference value between a measurement result (the fall time t_{f} of the light reception response) of the first time calculator 61 based on the first threshold Vₜₕ₁ and a measurement result (the fall time t_{f} of the light reception response) of the second time calculator 62 based on the second threshold Vₜₕ₂.

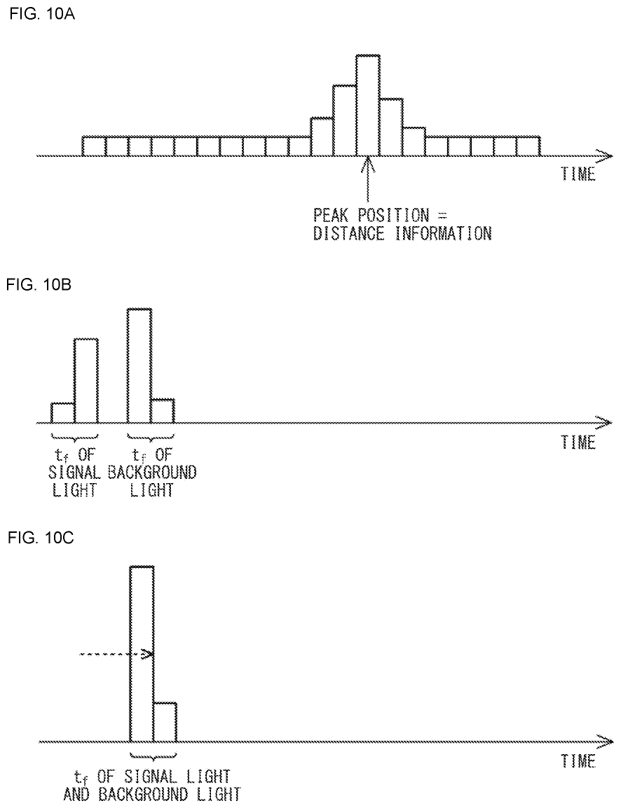

The time measurement at the first time calculator 61 is executed a plurality of times. The ToF histogram generator 632 generates a histogram of the ToF by accumulating up measured times based on the first threshold Vₜₕ₁ obtained by the plurality of times of measurement at the first time calculator 61. The ToF histogram is illustrated in FIG. 10A. In the ToF histogram, the peak position of the histogram serves as the distance information. In other words, by measuring a time of the peak position of the ToF histogram, it is possible to determine the distance to the subject on the basis of the time.

Here, in a case where the intensity of the signal light is excessively high, there is a possibility of a shift of the ToF histogram toward the left, and therefore it is necessary to check the fall time t_{f} of the light reception response of the SPAD element 51. FIG. 10B illustrates a fall time t_{f} histogram in the case where the intensity of the signal light is excessively high. The fall time t_{f} histogram generator 633 generates a histogram of the fall time t_{f} on the basis of an output of the subtractor 631, that is, difference value information between the measurement result of the first time calculator 61 and the measurement result of the second time calculator 62. The average computing section 634 calculates an average value of the histogram of the fall time t_{f} generated by the fall time t_{f} histogram generator 633 as the fall time t_{f} of the light reception response of the SPAD element 51.

As illustrated in FIG. 10B, in the case where the intensity of the signal light is excessively high, a histogram of the fall time t_{f} for the signal light and a histogram of the fall time t_{f} for the background light are separated from each other. It is to be noted that if the resolution of each of the first time calculator 61 and the second time calculator 62 is finer, it is easier for the histogram of the fall time t_{f} for the signal light and the histogram of the fall time t_{f} for the background light to be separated from each other, and it is therefore possible to take an average value correctly. However, even if the histogram of the fall time t_{f} for the signal light and the histogram of the fall time t_{f} for the background light are not separated from each other, there is no problem because it is possible to perform the feedback control.

In a case where the intensity of the signal light is appropriate, the feedback control is exercised to weaken the intensity (light emission amount) of the laser light source 22 and/or to reduce the sensitivity (detection efficiency PDE) of the SPAD element 51 until the histogram of the fall time t_{f} for the signal light and the histogram of the fall time t_{f} for the background light overlap as illustrated in FIG. 10C.

In the light reception device including the computing unit 63 according to Example 1 having the above-described configuration, the computing unit 63 is able to determine the fall time t_{f} of the light reception response of the SPAD element 51 from the output of the subtractor 631, that is, the difference value information between the measurement result of the first time calculator 61 and the measurement result of the second time calculator 62, and to acquire the photon flux density (illuminance) from a result of the computation thereof. In other words, the computing unit 63 according to Example 1 is usable as a photon flux density meter (illuminance meter).

In other words, the light reception device including the computing unit 63 according to Example 1 can be said to be a light reception device using a photon flux density meter (illuminance meter) that determines the fall time t_{f} of the light reception response of the SPAD element 51 from the difference value information of the subtractor 631 and acquires the photon flux density (illuminance) from a result thereof. In this case, on the basis of the information of the photon flux density (illuminance) acquired with the photon flux density meter (illuminance meter), feedback control is performed on at least one of the light emission amount of the laser light source 22 and the sensitivity (detection efficiency PDE) of the SPAD element 51 until an intended illuminance value is reached.

As described above, the light reception device including the computing unit 63 according to Example 1 has a configuration using the computing unit 63 that generates a histogram of the difference value between the measurement result of the first time calculator 61 and the measurement result of the second time calculator 62 by utilizing jitter (fluctuations) that the SPAD element 51 itself possesses, and performs appropriate average computation. By virtue of this configuration, although a time resolution of the TDC is greater than the fall time t_{f} of the light reception response of the SPAD element 51 which is a measurement target, it is possible to measure the fall time t_{f} with much finer accuracy than the time resolution of the TDC.

### Example 2

Example 2 is an example of each device arrangement of the laser light source 22 and the SPAD element 51 configured in a one-dimensional, two-dimensional, or three-dimensional array.

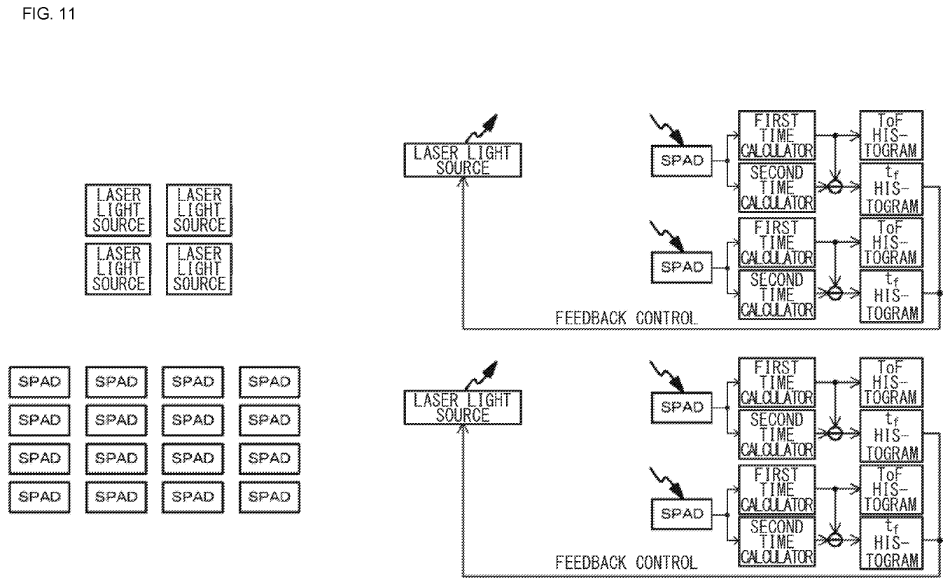

FIG. 11 illustrates a configuration example of a device arrangement according to Example 2. For simplifying the drawing, FIG. 11 omits the illustration of the average computing section 634 of the computing unit 63 and the controller 40. The laser light source 22 and the SPAD element 51 are in a 1-to-N (N≥1) correspondence relationship. Illustrated here is a case where N=2, that is, a case where two SPAD elements 51 are provided for one laser light source 22 by way of example.

In the distance measurement apparatus having the above-described configuration, feedback control is performed on the laser intensity (light emission amount) of each laser light source 22 independently in accordance with the illuminance information of each SPAD element 51 based on the difference value between the measurement result of the first time calculator 61 and the measurement result of the second time calculator 62. This feedback control stabilizes the photon flux density, thus making it possible to perform a highly reliable distance measurement.

It is to be noted that although a case where feedback control is performed on the laser intensity (light emission amount of the laser light source 22) in accordance with the illuminance information of the SPAD element 51 has been described here by way of example, the feedback control on the laser intensity is not limitative, and feedback control may be performed on the sensitivity (detection efficiency PDE) of the SPAD element 51.

### Example 3

Example 1 is an example in which the fall time t_{f} of the light reception response of the SPAD element 51 is acquired and, on the basis of the acquired information, feedback control is performed on the light emission amount of the laser light source 22/the sensitivity of the SPAD element 51. In contrast, Example 3 is an example in which a result of distance measurement (that is, acquired distance information) is corrected by the computing unit 63 using a correction table.

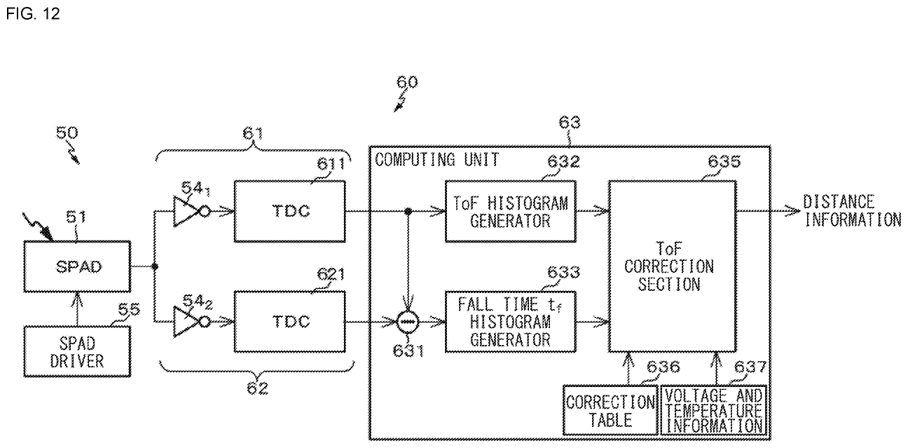

FIG. 12 illustrates an example of a configuration of a light reception device including the computing unit 63 according to Example 3. As illustrated in FIG. 12, the computing unit 63 has a configuration including a ToF correction section 635 and a correction table storage section 636, in addition to the subtractor 631, the ToF histogram generator 632, and the fall time t_{f} histogram generator 633. As the correction table storage section 636, a nonvolatile memory is usable. The nonvolatile memory may be configured to be provided inside the light reception device or configured to be provided outside the light reception device.

The correction table storage section 636 stores, in advance, a correction table in which illuminance information (photon flux density information) based on the difference value information between the measurement result of the first time calculator 61 and the measurement result of the second time calculator 62 and distance information to be corrected are associated with each other. On the basis of the fall time t_{f} of the light reception response determined by the fall time t_{f} histogram generator 633, the ToF correction section 635 corrects the distance information acquired by the ToF histogram generator 632, by using the correction table stored in the correction table storage section 636.

It is to be noted that voltage and temperature information 636 may be used when correction of the distance information is performed by the ToF correction section 635. This makes it possible to perform correction of the distance information with higher reliability.

### Example 4

Example 1 to Example 3 are examples in which the second time calculator 62 that measures the time when the response waveform of the SPAD element 51 falls below the second threshold Vₜₕ₂ is provided for each of all the SPAD elements 51. In contrast, Example 4 is an example of thinning out the provision of the second time calculators 62 relative to the SPAD elements 51.

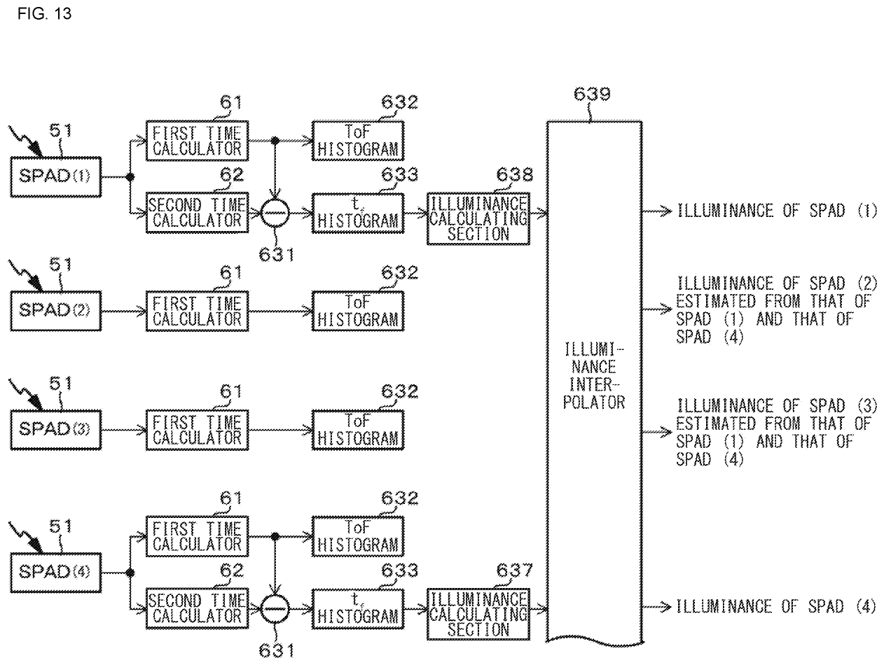

FIG. 13 illustrates an example of a configuration of a light reception device according to Example 4. For simplifying the drawing, FIG. 13 omits the illustration of the average computing section 634 of the computing unit 63 and the controller 40. The second time calculators 62 for acquiring the fall time t_{f} of the light reception response do not have to be provided for all the SPAD element 51, and the second time calculator 62 may be provided in a thinned-out manner relative to the SPAD elements 51 in the pixel array section into a two-dimensionally rough arrangement. Here, an example is illustrated in which, with three rows in the pixel array section as a unit, one second time calculator 62 is provided for every three rows.

FIG. 13 illustrates four SPAD elements 51 in four rows disposed to be adjacent to each other, for example. For the sake of convenience, the four SPAD elements 51 are denoted as a SPAD element (1), a SPAD element (2), a SPAD element (3), and a SPAD element (4).

The light reception device according to Example 4 includes an illuminance calculating section 638 and an illuminance interpolator 639. The illuminance calculating section 638 calculates, for the SPAD element (1), the illuminance of the SPAD element 51 by using the fall time t_{f} of the light reception response determined by the fall time t_{f} histogram generator 633. For each of the SPAD element (2) and the SPAD element (3), no second time calculator 62 is provided therein and therefore no calculation of the illuminance of the SPAD element 51 is performed.

Then, the illuminance interpolator 639 determines illuminances of the SPAD element (2) and the SPAD element (3) provided with no second time calculator 62 by interpolation computations. Specifically, for the SPAD element (1), the illuminance interpolator 639 outputs the illuminance determined by the illuminance calculating section 638 as it is. The illuminance of the SPAD element (2) is estimated from the illuminance of the SPAD element (1) and the illuminance of the SPAD element (4) by interpolation computations. The illuminance of the SPAD element (3) is also estimated from the illuminance of the SPAD element (1) and the illuminance of the SPAD element (4) by interpolation computations, as with the illuminance of the SPAD element (2).

According to the light reception device according to Example 4, the second time calculators 62 for acquiring the fall time t_{f} of the light reception response are not provided for all of the SPAD elements 51 but are provided in a thinned-out manner. This makes it possible to achieve a reduction in circuit scale as compared with a case of providing the second time calculators 62 for all the SPAD elements 51.

### Modification Examples

The technology according to the present disclosure has been described with reference to the preferred embodiments; however, the technology according to the present disclosure is not limited to the embodiments. The configurations and structures of the light reception device and the distance measurement apparatus described in the above embodiments are illustrative, and may be appropriately modified. For example, in the embodiments described above, a case where the SPAD element is used as the light-receiving element has been described as an example; however, the light-receiving element is not limited to the SPAD element, and similar workings and effects are achievable also in a case of using an element such as an APD or a CAPD.

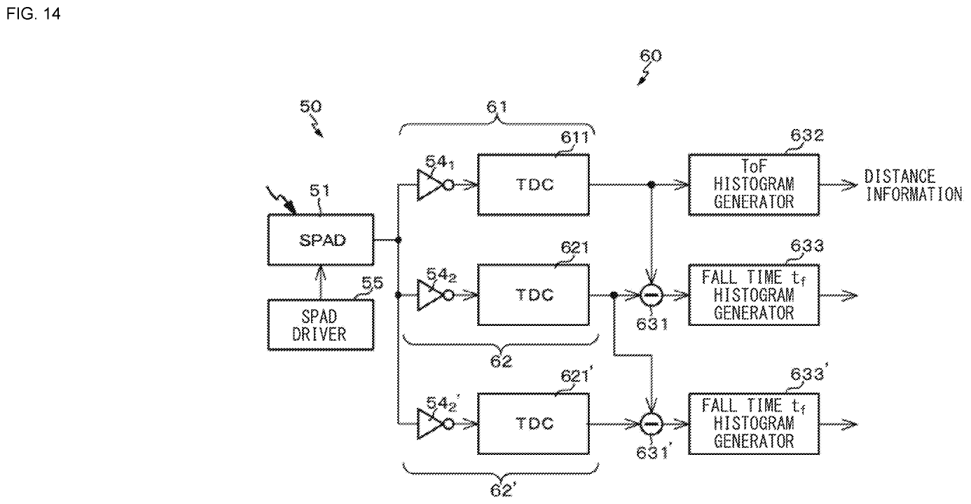

Further, in the embodiments described above, a case where two time measurement sections (that is, the first time calculator 61 and the second time calculator 62) are provided as the plurality of time measurement sections having thresholds different from each other has been described as an example; however, the number thereof is not limited to two. For example, FIG. 14 illustrates a configuration in a case where three (three systems of) time measurement sections each including a TDC are provided.

A light reception device according to the present modification example includes a third time calculator 62′ in addition to the first time calculator 61 and the second time calculator 62. The third time calculator 62′ includes a third inverter 54₂′ corresponding to the inverter 54 in FIG. 3 and a TDC 621′. The third time calculator 62′ has a third threshold Vₜₕ₃ smaller than the second threshold Vₜₕ₂ (Vₜₕ₁>Vₜₕ₂>Vₜₕ₃), and detects a fall of a light reception response based on entry of light into the SPAD element 51.

A subtractor 631′ and a fall time t_{f} histogram generator 633′ are provided at a subsequent stage to the third time calculator 62′. The subtractor 631′ determines a difference value between a measurement result of the second time calculator 62 based on the second threshold Vₜₕ₂ and a measurement result of the third time calculator 62′ based on the third threshold Vₜₕ₃. The fall time t_{f} histogram generator 633′ generates a histogram of the fall time t_{f} on the basis of an output of the subtractor 631′, that is, difference value information between the measurement result of the second time calculator 62 and the measurement result of the third time calculator 62′.

The technology of the present disclosure is applicable also to a case of a light reception device including four (four systems of) time measurement sections each including a TDC, as with the case of the light reception device including three (three systems of) time measurement sections each including a TDC.

Further, assuming that any far-distance measurement use or any fine distance-measurement performance is not required and that it is unnecessary to adjust the photon flux density (illuminance), a mechanism for reducing power supply to unnecessary circuits, for example, the TDCs and the histogram generators that are necessary only to acquire the fall time t_{f} or the rise time tᵣ of the light reception response, is implementable by employing a means such as power gating or clock gating.

### <Application Example of Technology According to Present Disclosure>

The technology according to the present disclosure is applicable to various products. A more specific application example is described below. For example, the technology according to the present disclosure may be implemented as a distance measurement apparatus to be installed aboard any kind of mobile body such as an automobile, an electric vehicle, a hybrid electric vehicle, a motorcycle, a bicycle, a personal mobility, an airplane, a drone, a vessel, a robot, a construction machine, and an agricultural machine (tractor).

### [Mobile Body]

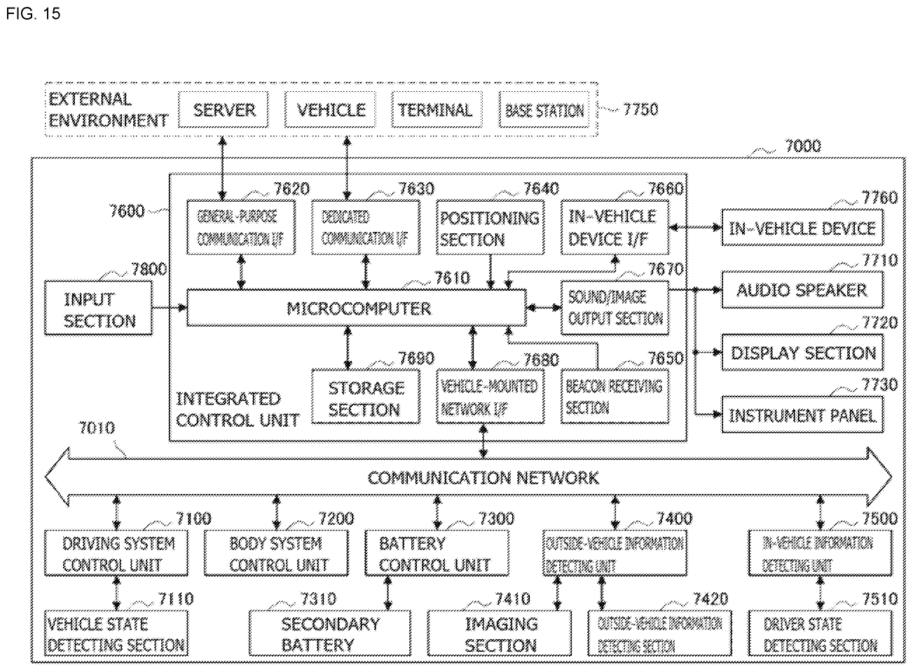

FIG. 15 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 15, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 15 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

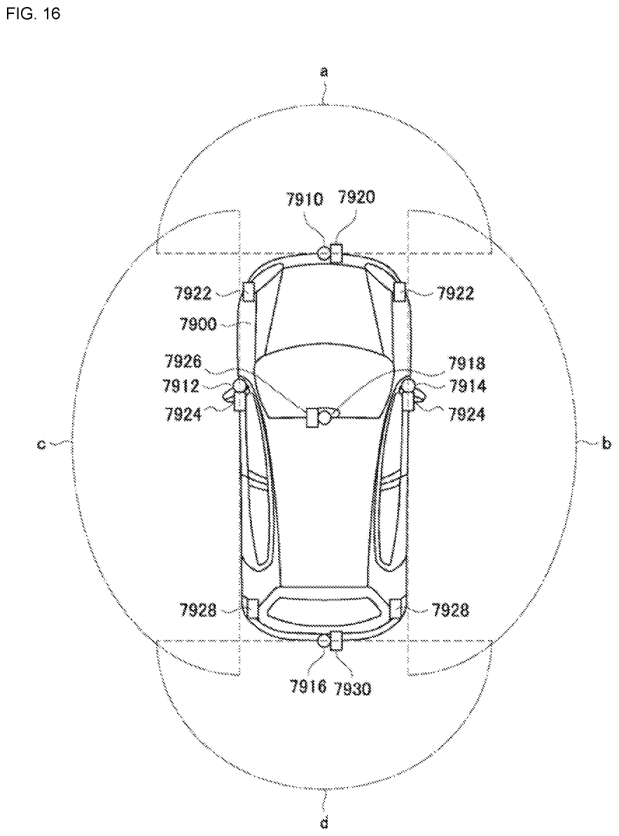

FIG. 16 depicts an example of installation positions of the imaging section 7410 and the outside-vehicle information detecting section 7420. Imaging sections 7910, 7912, 7914, 7916, and 7918 are, for example, disposed at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 16 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 15, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX), long term evolution (LTE), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 15, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 15 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

An example of the vehicle control system to which the technology according to the present disclosure is applicable has been described above. In a case where the imaging section 7410 among the configurations described above includes a ToF camera, the technology according to the present disclosure is applicable to the ToF camera. Then, applying the technology according to the present disclosure makes it possible to implement a light reception device that is able to perform a highly reliable distance measurement. In addition, by mounting the light reception device as a light reception device of the distance measurement apparatus, it is possible to construct a vehicle control system that is able to detect a measurement target with high accuracy, for example.

### <Possible Configurations of Present Disclosure>

It is to be noted that the present disclosure may also have the following configurations.

### <<A. Light Reception Device>>

[A-1] A light reception device including:

a light-receiving element that receives reflected light from a subject based on projection of light from a light source;

a time calculator that calculates a rise time or a fall time of a light reception response based on entry of light into the light-receiving element; and

a controller that outputs a control signal for controlling at least one of a light emission amount of the light source and a sensitivity of the light-receiving element on the basis of the rise time or the fall time calculated by the time calculator.

[A-2] The light reception device according to [A-1], in which the controller controls the at least one of the light emission amount of the light source and the sensitivity of the light-receiving element to cause the rise time or the fall time calculated by the time calculator to become a predetermined reference time.
[A-3] The light reception device according to [A-2], in which the predetermined reference time is a rise time or a fall time of the light reception response when a distance measurement is performed under background light.
[A-4] The light reception device according to [A-2] or [A-3], in which the controller controls the light emission amount of the light source by changing a current value of a drive current of the light source.
[A-5] The light reception device according to [A-2] or [A-3], in which the controller controls the sensitivity of the light-receiving element by changing a voltage value of a voltage to be applied to the light-receiving element.
[A-6] The light reception device according to any one of [A-1] to [A-5], in which the time calculator includes a plurality of time calculators having thresholds different from each other.
[A-7] The light reception device according to [A-6], in which the plurality of time calculators includes combinations of inverters and time measurement sections.
[A-8] The light reception device according to [A-7], in which the thresholds of the plurality of time calculators different from each other are supplied by threshold voltages of the inverters.
[A-9] The light reception device according to [A-8], in which

the inverters include CMOS inverters, and

the thresholds of the plurality of time calculators different from each other are set by causing transistors included in the CMOS inverters to be different from each other in threshold voltage, or by causing the transistors to be different from each other in size ratio.

[A-10] The light reception device according to any one of [A-6] to [A-9], in which the time calculator includes a computing unit that calculates the rise time or the fall time of the light reception response on the basis of difference value information obtained from calculation results of the plurality of time calculators.
[A-11] The light reception device according to [A-10], in which the computing unit includes

a subtractor that obtains the difference value information on the basis of the calculation results of the plurality of time calculators,

a histogram generator that generates a histogram of the rise time or the fall time of the light reception response on the basis of the difference value information obtained by the subtractor, and

an average computing section that determines an average value of the histogram generated by the histogram generator as the rise time or the fall time of the light reception response.

[A-12] The light reception device according to any one of [A-1] to [A-12], in which the controller performs feedback control on the at least one of the light emission amount of the light source and the sensitivity of the light-receiving element on the basis of the rise time or the fall time calculated by the time calculator.
[A-13] The light reception device according to [A-10], in which the computing unit acquires a photon flux density from a calculation result of the rise time or the fall time of the light reception response.
[A-14] The light reception device according to [A-10], in which the computing unit includes

a subtractor that obtains the difference value information on the basis of the calculation results of the plurality of time calculators,

a histogram generator that generates a histogram of the rise time or the fall time of the light reception response on the basis of the difference value information obtained by the subtractor,

a correction table that associates photon flux density information based on the difference value information obtained by the subtractor and distance information to be corrected with each other, and

a correction section that corrects the distance information using the correction table on the basis of the rise time or the fall time of the light reception response.

[A-15] The light reception device according to any one of [A-6] to [A-14], in which

the time calculator includes
a first time calculator that calculates the rise time or the fall time of the light reception response with a first threshold as a reference, and
a second time calculator that calculates the rise time or the fall time of the light reception response with a second threshold different from the first threshold as a reference, and

the second time calculator is provided in a thinned-out manner relative to the light-receiving element in a pixel array section.

[A-16] The light reception device according to any one of [A-1] to [A-15], in which the light-receiving element includes an element that generates a signal in response to reception of a photon.
[A-17] The light reception device according to [A-16], in which the light-receiving element includes a single-photon avalanche diode.

### <<B. Distance Measurement Apparatus>>

[B-1] A distance measurement apparatus including

a light source that projects light onto a measurement target, and

a light reception device that receives light reflected off the measurement target,

the light reception device including:
a light-receiving element that receives reflected light from a subject based on projection of light from the light source;
a time calculator that calculates a rise time or a fall time of a light reception response based on entry of light into the light-receiving element; and
a controller that outputs a control signal for controlling at least one of a light emission amount of the light source and a sensitivity of the light-receiving element on the basis of the rise time or the fall time calculated by the time calculator.
   [B-2] The distance measurement apparatus according to [B-1], in which the controller controls the at least one of the light emission amount of the light source and the sensitivity of the light-receiving element to cause the rise time or the fall time calculated by the time calculator to become a predetermined reference time.
   [B-3] The distance measurement apparatus according to [B-2], in which the predetermined reference time is a rise time or a fall time of the light reception response when a distance measurement is performed under background light.
   [B-4] The distance measurement apparatus according to [B-2] or [B-3], in which the controller controls the light emission amount of the light source by changing a current value of a drive current of the light source.
   [B-5] The distance measurement apparatus according to [B-2] or [B-3], in which the controller controls the sensitivity of the light-receiving element by changing a voltage value of a voltage to be applied to the light-receiving element.
   [B-6] The distance measurement apparatus according to any one of [B-1] to [B-5], in which the time calculator includes a plurality of time calculators having thresholds different from each other.
   [B-7] The distance measurement apparatus according to [B-6], in which the plurality of time calculators includes combinations of inverters and time measurement sections.
   [B-8] The distance measurement apparatus according to [B-7], in which the thresholds of the plurality of time calculators different from each other are supplied by threshold voltages of the inverters.
   [B-9] The distance measurement apparatus according to [B-8], in which

the inverters include CMOS inverters, and

the thresholds of the plurality of time calculators different from each other are set by causing transistors included in the CMOS inverters to be different from each other in threshold voltage, or by causing the transistors to be different from each other in size ratio.

[B-10] The distance measurement apparatus according to any one of [B-6] to [B-9], in which the time calculator includes a computing unit that calculates the rise time or the fall time of the light reception response on the basis of difference value information obtained from calculation results of the plurality of time calculators.
[B-11] The distance measurement apparatus according to [B-10], in which the computing unit includes

a subtractor that obtains the difference value information on the basis of the calculation results of the plurality of time calculators,

a histogram generator that generates a histogram of the rise time or the fall time of the light reception response on the basis of the difference value information obtained by the subtractor, and

an average computing section that determines an average value of the histogram generated by the histogram generator as the rise time or the fall time of the light reception response.

[B-12] The distance measurement apparatus according to any one of [B-1] to [B-12], in which the controller performs feedback control on the at least one of the light emission amount of the light source and the sensitivity of the light-receiving element on the basis of the rise time or the fall time calculated by the time calculator.
[B-13] The distance measurement apparatus according to [B-10], in which the computing unit acquires a photon flux density from a calculation result of the rise time or the fall time of the light reception response.
[B-14] The distance measurement apparatus according to [B-10], in which the computing unit includes

a subtractor that obtains the difference value information on the basis of the calculation results of the plurality of time calculators,

a histogram generator that generates a histogram of the rise time or the fall time of the light reception response on the basis of the difference value information obtained by the subtractor,

a correction table that associates photon flux density information based on the difference value information obtained by the subtractor and distance information to be corrected with each other, and

a correction section that corrects the distance information using the correction table on the basis of the rise time or the fall time of the light reception response.

[B-15] The distance measurement apparatus according to any one of [B-6] to [B-14], in which

the time calculator includes
a first time calculator that calculates the rise time or the fall time of the light reception response with a first threshold as a reference, and
a second time calculator that calculates the rise time or the fall time of the light reception response with a second threshold different from the first threshold as a reference, and

the second time calculator is provided in a thinned-out manner relative to the light-receiving element in a pixel array section.

[B-16] The distance measurement apparatus according to any one of [B-1] to [B-15], in which the light-receiving element includes an element that generates a signal in response to reception of a photon.
[B-17] The distance measurement apparatus according to [B-16], in which the light-receiving element includes a single-photon avalanche diode.
[B-18] The distance measurement apparatus according to any one of [B-1] to [B-18], in which

the light source and the light-receiving element are configured in a one-dimensional, two-dimensional, or three-dimensional array, and

when the light source and the light-receiving element are in a 1-to-N (N≥1) correspondence relationship, feedback control is performed on the light emission amount of each light source independently in accordance with illuminance information of the light-receiving element.

### REFERENCE SIGNS LIST

1 . . . distance measurement apparatus, 10 . . . subject (measurement target), 20 . . . light source, 21 . . . laser driver, 22 . . . laser light source, 23 . . . diffusion lens, 30 . . . light reception device, 31 . . . light-receiving lens, 32 . . . optical sensor, 33 . . . signal processor, 40 . . . controller, 50 . . . pixel, 51 . . . SPAD element, 54, 54₁, 54₂ . . . inverter, 55 . . . SPAD driver, 60 . . . time calculator, 61 . . . first time calculator, 62 . . . second time calculator, 63 . . . computing unit, 631 . . . subtractor, 632 . . . ToF histogram generator, 633 . . . fall time t_{f} histogram generator, 634 . . . average computing section, 635 . . . ToF correction section, 636 . . . correction table storage section, 637 . . . voltage and temperature information storage section, 638 . . . illuminance calculating section, 639 . . . illuminance interpolator

1. A light reception device comprising:
a light-receiving element that receives reflected light from a subject based on projection of light from a light source;
a time calculator that calculates a rise time or a fall time of a light reception response based on entry of light into the light-receiving element; and
a controller that outputs a control signal for controlling at least one of a light emission amount of the light source and a sensitivity of the light-receiving element on a basis of the rise time or the fall time calculated by the time calculator.

2. The light reception device according to claim 1, wherein the controller controls the at least one of the light emission amount of the light source and the sensitivity of the light-receiving element to cause the rise time or the fall time calculated by the time calculator to become a predetermined reference time.

3. The light reception device according to claim 2, wherein the predetermined reference time is a rise time or a fall time of the light reception response when a distance measurement is performed under background light.

4. The light reception device according to claim 2, wherein the controller controls the light emission amount of the light source by changing a current value of a drive current of the light source.

5. The light reception device according to claim 2, wherein the controller controls the sensitivity of the light-receiving element by changing a voltage value of a voltage to be applied to the light-receiving element.

6. The light reception device according to claim 1, wherein the time calculator includes a plurality of the time calculators having thresholds different from each other.

7. The light reception device according to claim 6, wherein the plurality of time calculators includes combinations of inverters and time measurement sections.

8. The light reception device according to claim 7, wherein the thresholds of the plurality of time calculators different from each other are supplied by threshold voltages of the inverters.

9. The light reception device according to claim 8, wherein
the inverters comprise CMOS inverters, and
the thresholds of the plurality of time calculators different from each other are set by causing transistors included in the CMOS inverters to be different from each other in threshold voltage, or by causing the transistors to be different from each other in size ratio.

10. The light reception device according to claim 6, wherein the time calculator includes a computing unit that calculates the rise time or the fall time of the light reception response on a basis of difference value information obtained from calculation results of the plurality of time calculators.

11. The light reception device according to claim 10, wherein the computing unit includes
a subtractor that obtains the difference value information on a basis of the calculation results of the plurality of time calculators,
a histogram generator that generates a histogram of the rise time or the fall time of the light reception response on the basis of the difference value information obtained by the subtractor, and
an average computing section that determines an average value of the histogram generated by the histogram generator as the rise time or the fall time of the light reception response.

12. The light reception device according to claim 1, wherein the controller performs feedback control on the at least one of the light emission amount of the light source and the sensitivity of the light-receiving element on the basis of the rise time or the fall time calculated by the time calculator.

13. The light reception device according to claim 10, wherein the computing unit acquires a photon flux density from a calculation result of the rise time or the fall time of the light reception response.

14. The light reception device according to claim 10, wherein the computing unit includes
a subtractor that obtains the difference value information on a basis of the calculation results of the plurality of time calculators,
a histogram generator that generates a histogram of the rise time or the fall time of the light reception response on the basis of the difference value information obtained by the subtractor,
a correction table that associates photon flux density information based on the difference value information obtained by the subtractor and distance information to be corrected with each other, and
a correction section that corrects the distance information using the correction table on the basis of the rise time or the fall time of the light reception response.

15. The light reception device according to claim 6, wherein
the time calculator includes
a first time calculator that calculates the rise time or the fall time of the light reception response with a first threshold as a reference, and
a second time calculator that calculates the rise time or the fall time of the light reception response with a second threshold different from the first threshold as a reference, and
the second time calculator is provided in a thinned-out manner relative to the light-receiving element in a pixel array section.

16. The light reception device according to claim 1, wherein the light-receiving element comprises an element that generates a signal in response to reception of a photon.

17. The light reception device according to claim 16, wherein the light-receiving element includes a single-photon avalanche diode.

18. A distance measurement apparatus comprising
a light source that projects light onto a measurement target, and
a light reception device that receives light reflected off the measurement target,
the light reception device including:
a light-receiving element that receives reflected light from a subject based on projection of light from the light source;
a time calculator that calculates a rise time or a fall time of a light reception response based on entry of light into the light-receiving element; and
a controller that outputs a control signal for controlling at least one of a light emission amount of the light source and a sensitivity of the light-receiving element on a basis of the rise time or the fall time calculated by the time calculator.

19. The distance measurement apparatus according to claim 18, wherein
the light source and the light-receiving element are configured in a one-dimensional, two-dimensional, or three-dimensional array, and
when the light source and the light-receiving element are in a 1-to-N (N≥1) correspondence relationship, feedback control is performed on the light emission amount of each light source independently in accordance with illuminance information of the light-receiving element.

20. A method of controlling a distance measurement apparatus, the distance measurement apparatus including
a light source that projects light onto a measurement target, and
a light reception device that receives light reflected off the measurement target,
the method comprising:
in control of the light reception device,
calculating a rise time or a fall time of a light reception response of a light-receiving element that receives reflected light from a subject based on projection of light from the light source; and
outputting a control signal for controlling at least one of a light emission amount of the light source and a sensitivity of the light-receiving element on a basis of the rise time or the fall time calculated.
